(19) United States
(12) Patent Application Publication
(10) Pub. No.: US 2011/0215632 A1
(43) Pub. Date: Sep. 8, 2011

(54) MANUFACTURE OF SEATS

(76) Inventor: Sylvain Gleyal, Cedex (FR)

(21) Appl. No.: 12/997,195

(22) PCT Filed: Jun. 9, 2009
(86) PCT No.: PCT/EP09/04137

§ 371 Date: May 25, 2011

(30) Foreign Application Priority Data
Jun. 9, 2008 (GB) 0810518.1

(51) Int. Cl. B60N 2/44; B32B 37/18

(52) U.S. Cl. 297/452.1; 156/275.5; 156/272.6

(57) ABSTRACT

The use of a structural adhesive to bond together components of an automobile seat reduces or eliminates the need for welding and can be used to bond together components of different materials; the adhesive can be activated by the heat employed in the provision of an anticorrosion coating on metal components.

### BACKGROUND

1. Field of the Disclosure

The present disclosure relates to improvements in or relating to seating and in particular to seating that is used in moving environments where protection against crash and/or changes in velocity is required. The disclosure is particularly useful in seating used in transportation such as in automobiles including passenger cars, trucks and busses and in trains and aircraft. The disclosure further provides an improved process for the manufacture of such seating.

2. Discussion of the Background Art

Seating, particularly for use in automobiles is frequently based on a hollow metal frame consisting of tubular sections, box sections, or open sections such as U, C, I, G, W or other shaped sections which are made from stampings that are welded together. The frames are designed so that they can carry accessories such as a tilting mechanism, a mechanism for moving the seat backwards and forwards, heating and cooling elements and the associated electronics. The frames are also designed so that they can carry the various seating and cushioning materials that may be required and the frame is also provided with means whereby the seat may be positioned and secured within the vehicle.

Seats are required to be safe and to provide protection for the occupant during operation of the vehicle. In particular the seats are required to protect the occupant during acceleration and deceleration of the vehicle which can be repeated. In particular the seat is required to protect the occupant in the event of a crash. For example, the seat back of the back seat should provide protection against luggage which may be thrown against the back of the seat from the vehicle boot in the event of a crash. Equally the back of the front seat needs to provide protection against impact from the rear as well as ensuring adequate security from the seat belts in the event of a crash. The strength requirements of seats are more and more being governed by regulations. The majority of the strength of the seat is provided by the metal frame. As the strength requirements have been increased the metal frames have been made of thicker metal and/or specialty high strength metals which have weight and/or cost debits.

In a further development of seats seat belts, rear and front seats, are at times being connected to the frame of the seat rather than to the pillar of the vehicle (such as the B and C pillar). This concept allows the same or similar seats to be used in different size and shaped vehicles and avoids the need to design and develop a unique seat for each vehicle. However this imposes an additional need to increase the strength of the frame to be able to take the strain exerted on the seat belt during a crash.

These developments are all taking place at a time when there is a general requirement to reduce the weight of vehicles to lower fuel consumption and reduce environmental pollution and the seats are a significant weight component in the vehicle.

The present disclosure provides a solution to these challenges, furthermore the disclosure can provide an improved method for assembling the various components of the seat.

In seat manufacture the metal frame is assembled by welding, the assembly cleaned and passed through an anti-corrosion bath, such as the electrocoat process and then baked and painted. Welding is an expensive and time consuming process with seat assembly often requiring a multitude of welds. Welding also suffers from the disadvantage that it cannot be used to bond together dissimilar materials such as plastic and metal. Furthermore it is difficult to produce satisfactory welds in confined spaces as can be found in the assembly of seating and seating frames.

### SUMMARY

We have now found that seat assembly can be made easier by the use of structural adhesives to bond together the components of the seat. Furthermore, we have found that by use of the adhesives welding can be reduced or eliminated. The use of the structural adhesives also enables different materials to be used in the seat providing weight saving opportunities. We have further found that the use of the structural adhesive provides sufficient strength to satisfy the safety requirement for seats.

A structural adhesive is a material that can be applied to one or both of the surfaces that are to be bonded together, the surfaces then brought together and the adhesive activated to form a bond between the two surfaces. It is preferred that the adhesive is not tacky to the touch after it has been applied and is activated by heat. The adhesive may be applied as a paste or provided as a strip or ribbon. The adhesive may be activated by any suitable means, it is preferably activated by heat to bond to the surfaces and in a preferred embodiment the adhesive is activated by the temperatures experienced in the anti-corrosion coat baking oven or the paint oven to which the seat frame is subjected. Alternatively, the adhesive may e activated by induction, infra-red radiation, microwaves and the like.

### BRIEF DESCRIPTION OF THE DRAWINGS

The present disclosure is illustrated by reference to the accompanying drawings in which

FIG. 1 shows a seat frame.

FIG. 2 shows two components of a seat frame to be bonded together and which are provided with conduits and through holes for cables and the like.

FIG. 3 is an end view of the two components shown in FIG. 2 bonded together.

FIG. 4 shows how the disclosure may be used to secure the arms of one component of a seat frame into channels formed in another component of the seat frame.

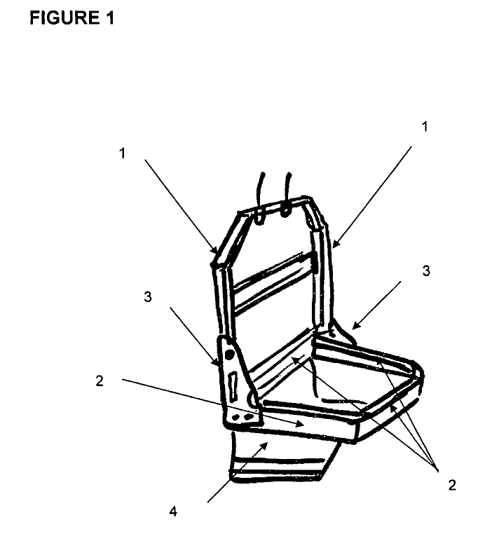

FIG. 1 shows how a seat frame is made up of a back section (1) joined to a seat section (2) by a joint piece (3) which allows movement of the back portion (1) relative to the seat portion (2). The seat also has lower support section (4). As can be seen there are many sections which must be secured to each other and the techniques of this disclosure are particularly suited for that purpose.

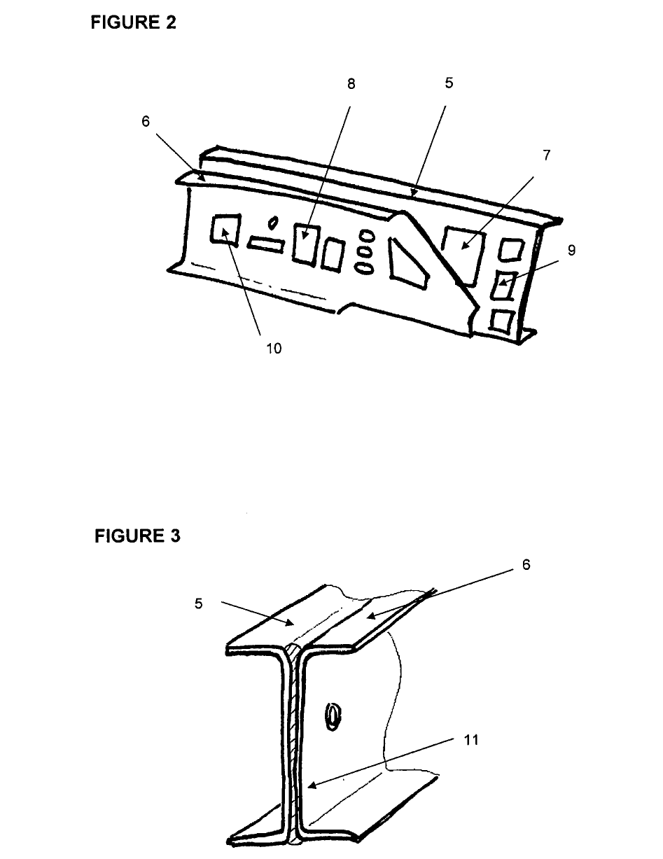

FIG. 2 shows two components of a seat (5) and (6) provided with through holes and conduits (7), (8), (9), (10) for cables and the like.

FIG. 3 shows the two components (5) and (6) bonded together by structural adhesive (11).

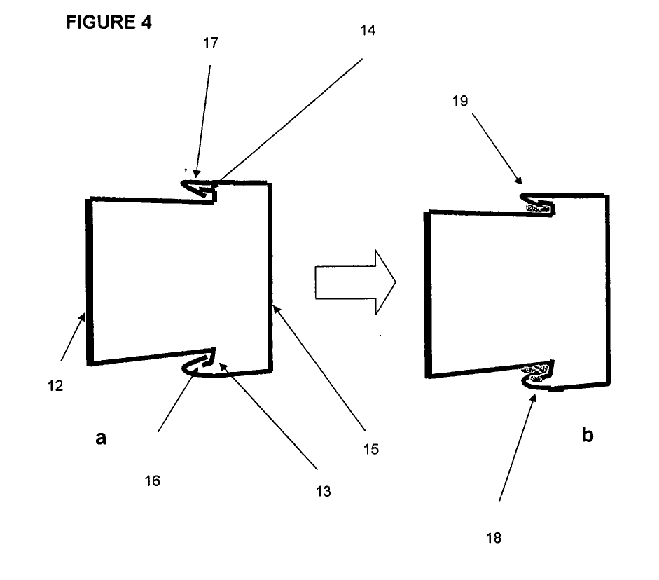

FIG. 4a shows how the component of a seat frame (12) can be provided with channels (13) and (14) and how a second component of a seat frame (15) can be provided with arms (16) and (17) to extend into the channels (13) and (14).

FIG. 4b shows how structural adhesive (18) and (19) can be provided in the channels to secure the arms.

### DETAILED DESCRIPTION OF THE PREFERRED EMBODIMENT

The present disclosure is applicable to the assembly of any components of the seat. For example it may be used to produce the back of a seat particularly to bond together panels to form the back of a rear seat of a vehicle. Equally the disclosure may be used to bond together the frame members of front seats including the frame to support the back portion of the seat, the cushion support frame or the lower side support part of the frame. Seats for automobiles become more and more complex as electronics for heating or cooling of the seat, movement of the seat, screens in the back of the seat are provided. It is therefore necessary to provide conduits and through holes in the seat frame for the passage of cables and the like. When welding is employed the areas where the conduits or through holes are provided can be difficult to weld which can result in a weak spot in the seat structure. The use of the structural adhesive at these positions has been found to increase the strength and durability of the seat.

In order to produce a finished seat frame various coating techniques are used. The frame may be powder painted, it may be provided with an anticorrosion coating by, for example, the electrocoat process or it may be dip coated. Whatever coating technique is used the structure should be prepared prior to coating. For example it should be cleaned of dust and dirt, it may be degreased either chemically or with compressed air. For powder coating it may be necessary to pre-phosphate. When the appropriate pre-treatment has been performed the seat frame may be powder coated with for example a powder coating that is baked for about 5 minutes. Alternatively it may be subjected to electrocoat anti-corrosion treatment and then baked at about 200° C.

If ACC is used the bake is typically performed at about 160° C. The structural adhesive used according to the present disclosure may therefore be selected so that it is activated at the baking temperatures that are used. Alternatively, other forms of activation may be used.

In a further embodiment of the disclosure one or more of the surfaces to be bonded may be treated to improve the adhesion such as by plasma discharge.

The disclosure is particularly useful to provide bonding in locations which are typically bonded by weld seams and weld flanges. The disclosure may also be used to bond arms of frames which are required to be bonded into channels such as U, C or W shaped channels formed in other components of the seat frame.

Any suitable structural adhesive may be used in the present disclosure and the adhesive should be selected according to the conditions employed during the manufacture of the seat frame and the desired activation technique. Examples of structural adhesives that may be used included polyurethane based adhesives and epoxy based adhesives. One particularly suitable adhesive is described in co-pending Application GB 0806434.7.

In one embodiment the structural adhesive used in the present disclosure may be an expandable material although unexpandable materials are more common. Where the material is expandable the disclosure includes applying the activatable material to a surface of a structure in an unexpanded or partially expanded state and activating the material for expanding (e.g., foaming) it to a volume greater than its volume in the unexpanded state (e.g., at least 5% greater, at least 50% greater, at least 200% greater. It is also typically preferred at least for reinforcement applications that the volumetric expansion such that the expanded volume is less than 400%, more typically less than 300%, even more typically less than 200% and possibly less than 100% relative to the original unexpanded volume. It is also contemplated that the volume of the material may be less after activation due to curing (e.g., cross-linking) for foamed or unfoamed versions of the activatable material.

We prefer that the structural adhesives used in the present disclosure is resistant to impact and does not fracture under conditions that may be experienced in an accident such as an automobile crash. It is also preferred that they function over the wide temperature range to which they may be subjected typically −40° C. to 90° C. although higher temperatures may be experienced.

The preferred performance of a structural adhesive for use in this disclosure is good Lap Shear, high T Peel and good performance in the Wedge Impact Test over the range of temperatures and environmental conditions. Other desirable properties include good adhesion durability under various types of exposure conditions such as high humidity, salt water and high and low temperatures with maintenance of the physical properties over time. In certain applications a high elastic modulus, a high Tg, high strain to failure and other physical properties may be desired.

The preferred adhesive for use in the present disclosure therefore comprises

i) an adduct of an epoxy resin and an elastomer;

ii) a phenoxy resin;

iii) a core/shell polymer;

iv) a curing agent.

The adhesive formulations may in addition contain other ingredients.

### The Adduct

The epoxy elastomer adduct imparts flexibility to the structural adhesive and the ability to initiate plastic deformation. Various epoxy/elastomer adducts may be employed in the adhesive used in the present disclosure. The epoxy/elastomer hybrid or adduct may be included in an amount of up to about 50% by weight of the structural adhesive. The epoxy elastomer adduct is approximately at least 5%, more typically at least 7% and even more typically at least 10% by weight of the structural adhesive and more preferably about 5% to 20% by weight of the adduct based on the structural adhesive. The elastomer-containing adduct may be a combination of two or more particular adducts and the adducts may be solid adducts, liquid adducts or semi-solids at a temperature of 23° C. or may also be combinations thereof. In one preferred embodiment, the adduct is composed of substantially entirely (i.e., at least 70%, 80%, 90% or more) of one or more adducts that are solid at a temperature of 23° C. We have found unexpectedly that when the adduct is used together with the core/shell polymer and the phenoxy resin desirable adhesive performance can be achieved over a wide range of temperatures employing a relatively small amount of the adduct. This lower amount of adduct such as 5% to 15% by weight imparts high temperature stability to the structural adhesive since there is little undesirable lowering of the Tg of the formulation.

The adduct itself generally includes about 1:5 to 5:1 parts of epoxy to elastomer, and more preferably about 1:3 to 3:1 parts of epoxy to elastomer. More typically, the adduct includes at least about 10%, more typically at least about 20% and even more typically at least about 40% elastomer and also typically includes not greater than about 60%, although higher or lower percentages are possible. The elastomer compound suitable for the adduct may be a thermosetting elastomer, although not required. Exemplary elastomers include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. In one embodiment, recycled tire rubber is employed. Examples of additional or alternative epoxy/elastomer or other adducts suitable for use in the present disclosure are disclosed in U.S. Patent Publication 2004/0204551.

The elastomer-containing adduct is included to modify structural properties of the structural adhesive such as strength, toughness, stiffness, flexural modulus, or the like. Additionally, the elastomer-containing adduct may be selected to render the structural adhesive more compatible with coatings such as water-borne paint or primer system or other conventional coatings.

### Phenoxy Resins

Phenoxy resins are high molecular weight thermoplastic condensation products of bisphenol A and epichloro-hydrin and their derivatives. Typically the phenoxy resins that are employed are of the basic formula

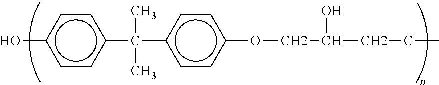

where n is typically from 30 to 100 preferably from 50 to 90. Modified phenoxy resins may also be used. Examples of phenoxy resins that may be used are the products marketed by Inchem Corp. Examples of suitable materials are the PKHB, PKHC, PKHH, PKHJ, PKHP pellets and powder. Alternatively phenoxy/polyester hybrids and epoxy/phenoxy hybrids may be used. It is preferred that the phenoxy resin be supplied to the other components as a solution and while any solvent may be used it is particularly preferred to use a liquid epoxy resin as the solvent as this can also contribute to the adhesive properties upon activation. When the structural adhesive is to be applied as a paste we prefer to use no more than 20% by weight of the phenoxy resin as higher amounts can result in too high a viscosity. However, higher percentages are effective for materials that are solid prior to activation.
The core/shell polymer

As used herein, the term core/shell polymer denotes a polymeric material wherein a substantial portion (e.g., greater than 30%, 50%, 70% or more by weight) thereof is comprised of a first polymeric material (i.e., the first or core material) that is substantially entirely encapsulated by a second polymeric material (i.e., the second or shell material). The first and second polymeric materials, as used herein, can be comprised of one, two, three or more polymers that are combined and/or reacted together (e.g., sequentially polymerized) or may be part of separate or same core/shell systems. The core/shell polymer should be compatible with the formulation and preferably has a ductile core and a rigid shell which is compatible with the other components of the structural adhesive formulation.

The first and second polymeric materials of the core/shell polymer can include elastomers, polymers, thermoplastics, copolymers, other components, combinations thereof or the like. In preferred embodiments, the first polymeric material, the second polymeric material or both include or are substantially entirely composed of (e.g., at least 70%, 80%, 90% or more by weight) one or more thermoplastics. Exemplary thermoplastics include, without limitation, styrenics, acrylonitriles, acrylates, acetates, polyamides, polyethylenes or the like.

Preferred core/shell polymers are formed by emulsion polymerization followed by coagulation or spray drying. It is also preferred for the core/shell polymer to be formed of or at least include a core-shell graft co-polymer. The first or core polymeric material of the graft copolymer preferably has a glass transition temperature substantially below (i.e., at least 10, 20, 40 or more degrees centigrade) the glass transition temperature of the second or shell polymeric material. Moreover, it may be desirable for the glass transition temperature of the first or core polymeric material to be below 23° C. while the glass temperature of the second or shell polymeric material to be above 23° C., although not required.

Examples of useful core-shell graft copolymers are those where hard containing compounds, such as styrene, acrylonitrile or methyl methacrylate, are grafted onto a core made from polymers of soft or elastomeric compounds such as butadiene or butyl acrylate. U.S. Pat. No 3,985,703, describes useful core-shell polymers, the cores of which are made from butyl acrylate but can be based on ethyl isobutyl, 2-ethylhexyl or other alkyl acrylates or mixtures thereof. The core polymer, may also include other copolymerizable containing compounds, such as styrene, vinyl acetate, methyl methacrylate, butadiene, isoprene, or the like. The core polymer material may also include a cross linking monomer having two or more nonconjugated double bonds of approximately equal reactivity such as ethylene glycol diacrylate, butylene glycol dimethacrylate, and the like. The core polymer material may also include a graft linking monomer having two or more nonconjugated double bonds of unequal reactivity such as, for example, diallyl maleate and allyl methacrylate.

The shell portion is preferably polymerized from methyl acrylates such as methyl methacrylate and optionally other alkyl acrylates and methacrylates, such as ethyl, butyl, or mixtures thereof acrylates or methacrylates as these materials are compatible with the phenoxy resin and any epoxy resins that are used in the formulation. Up to 40 percent by weight or more of the shell monomers may be styrene, vinyl acetate, vinyl chloride, and the like. Additional core-shell graft copolymers useful in embodiments of the present disclosure are described in U.S. Pat. Nos. 3,984,497; 4,096,202; 4,034,013; 3,944,631; 4,306,040; 4,495,324; 4,304,709; and 4,536,436. Examples of core-shell graft copolymers include, but are not limited to, “MBS” (methacrylate-butadiene-styrene) polymers, which are made by polymerizing methyl methacrylate in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

Examples of useful core/shell polymers include, but are not limited to those sold under the tradename, PARALOID, commercially available from Rohm & Haas Co. One particularly preferred grade of PARALOID impact modifier has a polymethyl methacrylate shell and an MBS core modifier and is sold under the designation EXL-2650; the product E-950 solid by Akema may also be used with equal effectiveness. We prefer to use from 5% to 30% of the core shell polymer particularly when the adhesive is to be applied as a paste as higher amounts can lead to an undesirably high viscosity.

### Curing Agent

One or more curing agents are included in the structural material used in this disclosure, the curing agent will be chosen according to the nature of the components of the adhesive and the activation that is to be used. Optionally curing agent accelerators may also be included. The amounts of curing agents and curing agent accelerators used can vary widely depending upon the type of structure desired, the desired structural properties of the activatable material and the like and in the embodiment when the material is expandable the desired amount of expansion of the activatable material and the desired rate of expansion. Exemplary ranges for the curing agents or curing agent accelerators present in the structural adhesive range from about 0.001% by weight to about 7% by weight.

Preferably, the curing agents assist the structural adhesive in curing by crosslinking of the polymers, phenoxy epoxy resins or both and any epoxy resin that may be present. It is also preferable for the curing agents to assist in thermosetting the structural adhesive. Useful classes of curing agents are materials selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. If an accelerator for the curing agent is used examples of materials includes a modified or unmodified urea such as methylene diphenyl bis urea, an imidazole or a combination thereof.

The structural adhesive used in this disclosure may contain other ingredients such as one or more of the following

i) epoxy resins;

ii) polymers;

iii) blowing agent;

iv) filler;

v) flow control materials and

vi) nano particles.

### Epoxy Resin

The preferred formulations of the present disclosure include epoxy resins both as solvent for the phenoxy resin and also as a component of the formulation. Epoxy resin is used herein to mean any of the conventional dimeric, oligomeric or polymeric epoxy materials containing at least one epoxy functional group. Moreover, the term epoxy resin can be used to denote one epoxy resin or a combination of multiple epoxy resins. The polymer-based materials may be epoxy-containing materials having one or more oxirane rings polymerizable by a ring opening reaction. In preferred embodiments, the structural adhesive includes between about 2% and 75% by weight epoxy resin, more preferably between about 4% and 60% by weight epoxy resin and even more preferably between about 25% and 50% by weight epoxy resin.

The epoxy may be aliphatic, cycloaliphatic, aromatic or the like. The epoxy may be supplied as a solid (e.g., as pellets, chunks, pieces or the like) or a liquid (e.g., an epoxy resin) although liquid resins are preferred to enhance processability of the adhesive formulation. As used herein, unless otherwise stated, a resin is a solid resin if it is solid at a temperature of 23° C. and is a liquid resin if it is a liquid at 23° C. The epoxy may include an ethylene copolymer or terpolymer. As a copolymer or terpolymer, the polymer is composed of two or three different monomers, i.e., small molecules with high chemical reactivity that are capable of linking up with similar molecules.

An epoxy resin may be added to the activatable material to increase the adhesion, flow properties or both of the material. One exemplary epoxy resin may be a phenolic resin, which may be a novolac type or other type resin. Other preferred epoxy containing materials may include a bisphenol-A epichlorohydrin ether polymer, or a bisphenol-A epoxy resin which may be modified with butadiene or another polymeric additive or bisphenol-F-type epoxy resins. Moreover, various mixtures of several different epoxy resins may be employed as well. Examples of suitable epoxy resins are sold under the tradename Araldite GY 282, GY 281 and GY 285 supplied by Huntsman.

### Polymer or Copolymer

The structural adhesive may include one or more additional polymers or copolymers, which can include a variety of different polymers, such as thermoplastics, elastomers, plastomers and combinations thereof or the like. For example, and without limitation, polymers that might be appropriately incorporated into the structural adhesive include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

When used, these polymers can comprise a small portion or a more substantial portion of the material. When used, the one or more additional polymers preferably comprises about 0.1% to about 50%, more preferably about 1% to about 20% and even more preferably about 2% to about 10% by weight of the structural adhesive.

In certain embodiments, it may be desirable to include one or more thermoplastic polyethers and/or thermoplastic epoxy resins in the structural adhesive. When included, the one or more thermoplastic polyethers preferably comprise between about 1% and about 90% by weight of the activatable material, more preferably between about 3% and about 60% by weight of the activatable material and even more preferably between about 4% and about 25% by weight of the activatable material. As with the other materials, however, more or less thermoplastic polyether may be employed depending upon the intended use of the activatable material.

The thermoplastic polyethers typically include pendant hydroxyl moieties. The thermoplastic polyethers may also include aromatic ether/amine repeating units in their backbones. The thermoplastic polyethers preferably have a melt index between about 5 and about 100, more preferably between about 25 and about 75 and even more preferably between about 40 and about 60 grams per 10 minutes for samples weighing 2.16 Kg at a temperature of about 190° C. Of course, the thermoplastic polyethers may have higher or lower melt indices depending upon their intended application. Preferred thermoplastic polyethers include, without limitation, polyetheramines, poly(amino ethers), copolymers of monoethanolamine and diglycidyl ether, combinations thereof or the like.

Preferably, the thermoplastic polyethers are formed by reacting an amine with an average functionality of 2 or less (e.g., a difunctional amine) with a glycidyl ether (e.g., a diglycidyl ether). As used herein, the term difunctional amine refers to an amine with an average of two reactive groups (e.g., reactive hydrogens).

According to one embodiment, the thermoplastic polyether is formed by reacting a primary amine, a bis(secondary) diamine, a cyclic diamine, a combination thereof or the like (e.g., monoethanolamine) with a diglycidyl ether or by reacting an amine with an epoxy-functionalized poly(alkylene oxide) to form a poly(amino ether). According to another embodiment, the thermoplastic polyether is prepared by reacting a difunctional amine with a diglycidyl ether or diepoxy-functionalized poly(alkylene oxide) under conditions sufficient to cause the amine moieties to react with the epoxy moieties to form a polymer backbone having amine linkages, ether linkages and pendant hydroxyl moieties. Optionally, the polymer may be treated with a monofunctional nucleophile which may or may not be a primary or secondary amine.

Additionally, it is contemplated that amines (e.g., cyclic amines) with one reactive group (e.g., one reactive hydrogen) may be employed for forming the thermoplastic polyether. Advantageously, such amines may assist in controlling the molecular weight of the thermoplastic ether formed.

Examples of preferred thermoplastic polyethers and their methods of formation are disclosed in U.S. Pat. Nos. 5,275,853; 5,464924 and 5,962,093. Advantageously, the thermoplastic polyethers can provide the structural adhesive with various desirable characteristics such as desirable physical and chemical properties for a wide variety of applications as is further described herein.

Although not required, the formulation may include one or more ethylene polymers or copolymers such as ethylene acrylates, ethylene acetates or the like. Ethylene methacrylate and ethylene vinyl acetate are two preferred ethylene copolymers.

It may also be desirable to include a reactive polyethylene resin that is modified with one or more reactive groups such as glycidyl methacrylate or maleic anhydride. Examples of such polyethylene resins are sold under the tradename LOTADER® (e.g., LOTADER AX 8900) and are commercially available from Arkema Group.

### Blowing Agent

The disclosure envisages the use of both non-expandable and expandable structural adhesives although non-expandable materials are more typical. If the activatable material is expandable one or more blowing agents may be added to the activatable material for producing inert gasses that form, as desired, an open and/or closed cellular structure within the structural adhesive. In this manner, it may be possible to lower the weight of the seat. In addition, the material expansion can help to improve sealing capability, acoustic damping and adhesion to bonding substrate.

The blowing agent may include one or more nitrogen containing groups such as amides, amines and the like. Examples of suitable blowing agents include azodicarbonamide, dinitrosopentamethylenetetramine, azodicarbonamide, dinitrosopentamethylenetetramine, 4,4ᵢ-oxy-bis-(benzenesulphonylhydrazide), trihydrazinotriazine and N, Nᵢ-dimethyl-N, Nᵢ-dinitrosoterephthalamide. An accelerator for the blowing agents may also be provided in the activatable material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles.

Amounts of blowing agents and blowing agent accelerators can vary widely within the activatable material depending upon the type of cellular structure desired, the desired amount of expansion of the activatable material, the desired rate of expansion and the like. Exemplary ranges for the amounts of blowing agents and blowing agent accelerators in the activatable material range from about 0.001% by weight to about 5% by weight and are preferably in the structural adhesive in fractions of weight percentages.

### Filler

The structural adhesive may also include one or more fillers, including but not limited to particulate materials (e.g., powder), beads, microspheres such as Zeospheres available from Zeelan Industries, or the like. Preferably the filler includes a material that is generally non-reactive with the other components present in the activatable material. While the fillers may generally be present within the activatable material to take up space at a relatively low weight, it is contemplated that the fillers may also impart properties such as strength and impact resistance.

Examples of fillers include silica, diatomaceous earth, glass, clay (e.g., including nanoclay), talc, pigments, colorants, glass beads or bubbles, glass, carbon or ceramic fibers, nylon or polyamide fibers (e.g., Kevlar), antioxidants, and the like. Such fillers, particularly clays, can assist the activatable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers.

When employed, the fillers in the structural adhesive can range from 10% or less to 90% or greater by weight of the activatable material, but more typical from about 20 to 55% by weight of the activatable material. According to some embodiments, the activatable material may include from about 0% to about 3% by weight, and more preferably slightly less that 1% by weight clays or similar fillers. Powdered (e.g. about 0.01 to about 50, and more preferably about 1 to 25 micron mean particle diameter) mineral type filler can comprise between about 5% and 70% by weight, more preferably about 10% to about 50% by weight.

### Other Components and Additives

Other additives, agents or performance modifiers may also be included in the structural adhesive as desired, including but not limited to an antioxidant, a UV resistant agent, a flame retardant, an impact modifier, a heat stabilizer, a colorant, a processing aid, a lubricant, a reinforcement (e.g., chopped or continuous glass, ceramic, aramid, or carbon fiber, particulates or the like). Liquid polysufides may be used to improve the environmental exposure of the adhesive such as exposure to humidity and salt water.

When determining appropriate components for the structural adhesive, it may be important to form the material such that it will only activate (e.g., flow, foam or otherwise change states) at appropriate times or temperatures. For instance, in some applications, it is undesirable for the material to be reactive at room temperature or otherwise at the ambient temperature in a production environment. More typically, the activatable material becomes activated to flow at higher processing temperatures. As an example, temperatures such as those encountered in an automobile assembly plant may be appropriate, especially when the activatable material is processed along with the other components at elevated temperatures or at higher applied energy levels, e.g., during painting preparation steps. Temperatures encountered in many coating operations (e.g., in a paint and/or e-coat curing oven), for instance, range up to about 250° C. or higher.

We prefer that the structural adhesive contain from 3% to 25% by weight of the epoxy/elastomer adduct, from 3% to 20% of the phenoxy resin and from 5% to 30% of the core/shell polymer; 1% to 10% of a curing agent. Preferred amounts of the other optional ingredients are as follows; 5% to 75% of one or more epoxy resins, preferably a liquid epoxy resin, 0.2% to 3% of a cure accelerator, 0.1% to 50% mineral filler, 0.1% to 3.0% clay and/or silica.

According to the present disclosure the structural adhesive is typically applied to a surface or substrate of a component of the seat frame and activated to cure the adhesive; activation typically occurs at elevated temperatures in the range 140° C. to 200° C. The time required depending upon the temperature employed with 30 minutes being typical. Activation of the material may also include at least some degree of foaming or bubbling in situations where the activatable material includes a blowing agent. Such foaming or bubbling can assist the activatable material in wetting a substrate and forming an intimate bond with the substrate. Alternatively, the structural adhesive may be activated to substantially wet the surfaces to form an intimate bond.

A structural adhesive suitable for use in the present disclosure is illustrated by reference to the following examples in which the following materials were first prepared.

40% of the phenoxy resin PKHJ from Inchem Corp was dissolved in 60% of the Bisphenol F liquid epoxy resin Epalloy 8220 from CVC Specialty Chemicals held at 180° C. The mixture was stirred in a high speed mixer for about 30 minutes. 50 wt % of this product was then mixed with 50% of the commercial material Paraloid EXL 2650 from Rohm and Haas to produce a masterbatch with the purpose of properly dispersing the Paraloid.

An epoxy elastomer adduct was prepared by reacting 60% of the Bisphenol A based Epoxy resin Araldite 6071 with 20% of each of the two liquid elastomers Hycar 1300×8 and Hycar 1300×13 available from Emerald.

The following formulation was then prepared.

| Ingredient | Grams |
|---|---|
| Masterbatch | 105 |
| Epoxy elastomer adduct | 30 |
| Epalloy 8220 | 140 |
| Kaneka MX 136 | 12 |
| (25% core/shell polymer dissolved in | |
| 75% Bisphenol F epoxy resin) | |
| Dicydianamide (Amicure CG 1200) | 20 |
| Omicure 52 | 2 |
| Calcibrite OG calcium carbonate | 75 |
| Nanopox 510 | 20 |
| (40% nano particle size silica in | |
| 60% Bisphenol F epoxy resin) | |

Masterbatch and the adduct are placed into a sigma blade mixer/extruder, the Nanopox and the Kaneka are then added followed by the calcium carbonate and the epoxy resin. Finally the dicydianamide and the omicure are added and the materials mixed for about 15 minutes and a vacuum is applied to remove any entrapped air.

1-14. (canceled)

15. A process for the production of automobile seats comprising applying a structural adhesive to a surface or substrate of a first component, bringing the component into contact with a second component of the frame and activating to cure the adhesive.

16. A process according to claim 15 in which the adhesive is activated by heating to a temperature in the range 140° C. to 200° C.

17. A process according to claim 15 in which the adhesive is activated by induction, infra-red or microwave radiation.

18. An automobile seat comprising two or more components wherein at least two components are bonded together by a structural adhesive.

19. An automobile seat according to claim 18 wherein the structural adhesive is heat activated.

20. An automobile seat according to claim 18 wherein the structural adhesive is activated by induction, infra-red or microwave radiation.

21. An automobile seat according to claim 18 in which the two or more components are of different materials.

22. An automobile seat according to claim 18 in which the two or more components are of metal.

23. (canceled)

24. A process according to claim 15 in which the components are of different materials.

25. A process according to claim 15 in which the components are of metal.

26. A process according to claim 15 in which the adhesive is applied as a paste or provided as a strip or ribbon.

27. A process according to claim 15 in which the adhesive is activated by the temperatures experienced in the anti-corrosion coat baking oven or the paint oven to which the seat frame is subjected.

28. A process according to claim 15 comprising bonding together panels to form the back of a rear seat of a vehicle.

29. A process according to claim 15 comprising bonding together the frame members of front seats including the frame to support the back portion of the seat, the cushion support frame or the lower side support part of the frame.

30. A process according to claim 15 in which one or more of the surfaces to be bonded is treated to improve the adhesion such as by plasma discharge.

31. A process according to claim 15 comprising bonding arms of frames into channels such as U, C or W shaped channels formed in other components of the seat frame.

32. A process according to claim 15 in which the adhesive comprises
i. an adduct of an epoxy resin and an elastomer;
ii. a phenoxy resin.
